(19) United States
(12) Patent Application Publication
(10) Pub. No.: US 2004/0148061 A1
(43) Pub. Date: Jul. 29, 2004

(54) Partial shut-down of individual functions of the system components of a vehicle as a function of maximum load

(76) Inventors: Norbert Polzin, Zaberfeld (DE); Alfred Sigl, Heidelberg (DE)

Correspondence Address: KENYON & KENYON, ONE BROADWAY, NEW YORK, NY, 10004, US

(21) Appl. No.: 10/721,925

(22) Filed: Nov. 25, 2003

(30) Foreign Application Priority Data
Nov. 25, 2002 (DE) 102 54 819.6-34

(51) Int. Cl. G06F 17/00

(52) U.S. Cl. 701/1; 701/29

(57) ABSTRACT

A method for monitoring at least one hydraulic component in a vehicle. In this context, it is provided that, for the monitoring, at least one wear-causing loading of the monitored component be measured and the measured loading be compared to at least one specifiable threshold value. In particular, the loading is measured on the basis of a braking request. The predefined threshold value represents a critical loading of the monitored components. Thus, the overloading of the monitored component may be detected by comparing the measured loading to the threshold value representing the critical loading. Suitable measures may be taken as a function of the executed comparison of the measured loading to the predefined threshold value. In this context, it is provided that the measures result in a reduction of the wear-causing loadings.

### FIELD OF THE INVENTION

The present invention relates to a method and a device for monitoring at least one hydraulic component in a vehicle, by measuring the wear-causing loading of the monitored components and comparing the loading to at least one threshold value.

### BACKGROUND INFORMATION

As technology advances, vehicles increasingly include additional functions, which are controlled by new open-loop and closed-loop control systems, but also by systems already present in the vehicle. These additional functions increase the loading of the system components in the vehicle, in particular in the case of parts subject to wear. Therefore, the automobile manufacturers and the automotive suppliers must make sure that the system components do not prematurely fail during the specified service life, due to the increased loading. The danger of unexpected functional failures occurring is particularly present in the case of subsequently implemented functions, which were not originally considered in the calculation of the maximum loading of a life cycle. Regarding the dimensioning of the system components, the vehicle manufacturer and the supplier must therefore find a happy medium between the specification of the maximum component loading and the overdimensioning of the components, which is to be avoided due to cost considerations.

German Published Patent Application No. 40 06 948 A1 describes the monitoring of the wear or the fatigue of two components. In it, the wear of the components in question during an essentially cyclical loading is monitored in a series of test runs. In this context, the instantaneous values of two measurable quantities occurring in the component are continually measured and converted into differential signals. After one loading cycle, these differential signals are compared to stored reference signals, which characterize the statistical distribution of the difference of the two measured quantities in the practically unused state of the component. The loading is only interrupted prematurely, when the differential signals considerably deviate from the reference signals.

With the aid of the present invention, the loading of at least one component may also be monitored by the relevant systems/functions during operation, along the lines of preventing overspecification, and it may optionally be reduced by appropriate measures. This consequentially possible reduction in the loading specifications or dimensions specific to the type of construction allows cost reductions to be attained.

### SUMMARY OF THE INVENTION

The present invention relates to a method for monitoring at least one hydraulic component in a vehicle. In this context, it is provided that, for the monitoring, at least one wear-causing loading of the monitored component be measured and the measured loading be compared to at least one specifiable threshold value. In particular, the present invention provides for the loading to be measured on the basis of a braking request. Now, according to the present invention, the predefined threshold value represents a critical loading of the monitored components. Thus, the overloading of the monitored component may be detected by comparing the measured loading to the threshold value representing the critical loading.

An advantageous refinement of the present invention introduces suitable measures as a function of the executed comparison of the measured loading to the predefined threshold value. In this context, it is provided that the measures result in a reduction of the wear-causing loadings.

In a particular refinement of the present invention, different loadings of the monitored hydraulic components are measured for the monitoring. In this context, these loadings may be both the instantaneous loading, which a monitored hydraulic component experiences during the operation of the vehicle, and/or the overall loading of the monitored, hydraulic components from previous loadings.

The detection of the loading exceeding the specifiable threshold value has an advantageous effect during the monitoring of the hydraulic components. In this context, it is possible to select a threshold value for different monitoring modes. Thus, it is possible to generate a threshold value for each monitored component and/or one common to at least two of the monitored components. This allows both individual monitoring of single components and the monitoring of an entire system formed by several components.

If it is determined that the measured loading exceeds at least one threshold value, then the control of the components in question is advantageously modified in the present invention. This modification may extend from limiting the functionality of the controlled system to completely shutting down the relevant open-loop and/or closed-loop control system. In a particular refinement of the present invention, the control of individual system functions is modified in at least two modes as a function of the loading.

In a further development of the present invention, the open-loop and/or closed-loop control systems of the monitored components are modified in two modes during the monitoring. During the modification, the minimization of the wear-causing loadings is in the fore. In a first mode, the control of open-loop and/or closed-loop control systems, which have at least one function in the vehicle relevant to travel comfort, is modified. The scope of this modification extends from changes in the control of the functions relevant to driving comfort, up to partial shut-down. A second mode is also activated as a function of the first mode. In the second mode, at least one open-loop and/or closed-loop control system controlling at least one function relevant to driving safety is likewise modified along the lines of minimizing the wear-causing loading. Thus, the response time, in which the function relevant to driving safety is initiated during operation, may be changed in the second mode. However, when the control of the functions relevant to driving safety is modified, the functions are not modified in such a manner that the driving safety of the vehicle is jeopardized at any time.

A further refinement of the present invention provides for the modification of the control of the systems to be prioritized. This relates to both the change in the control and the partial shut-down. Thus, e.g. comfort-relevant systems effecting only a small change in the performance, due to their influence, may initially be shut down in response to the detection of the component loadings being exceeded, before the control of another system is modified. Due to this prioritization, the driver only perceives the intervention in the control of the systems, as the level of modification increases.

In the present invention, the selection of the threshold value as a maximum loading of the system during operation has an advantageous effect. In order to unequivocally defined it, this maximum loading of the system may be stored in a non-volatile memory, e.g. by a service technician or during a routine visit to a garage after the exchange of a hydraulic component.

A further advantage of the present invention is that different hydraulic components may be designated for monitoring. Thus, at least a valve and/or a hydraulic fluid and/or a pump of the brake system may be monitored. However, components less susceptible to wear, i.e. low-wear components, may also be monitored.

Various systems in a vehicle may be designated for the modification of the control of an open-loop and/or closed-loop control system. Thus, is possible to appropriately minimize the wear-causing load by modifying the control of at least

a brake and/or

a differential and/or

a valve and/or

a pump and/or

the engine of the vehicle.

In this context, individual systems may fulfill functions relevant to both comfort and safety. In a particular refinement of the present invention, the vehicle in which the monitoring takes place contains

an anti-lock braking system (ABS) and/or

an electronic stability program (ESP) and/or

a traction control system (TCS) and/or

an adaptive cruise control (ACC) and/or

a vehicle dynamics control system (VDC) and/or

an automatic limited-slip differential (ALSD) and/or

an electromotive parking brake (EPB) and/or

an electrohydraulic brake (EHB) and/or

systems which influence the handling in the case of a gradient (hill descent, hill holder).

### BRIEF DESCRIPTION OF THE DRAWINGS

FIG. 1 illustrates a block diagram schematically showing the monitoring of the hydraulic components in the vehicle.

FIG. 2 shows a flow chart describing schematically the monitoring of the hydraulic components, including the measuring of the wear-causing loading, the comparison of the measured loading to predefined threshold values, and the initiation of suitable measures for minimizing the wear-causing loading.

### DETAILED DESCRIPTION

An exemplary embodiment, by which the monitoring of at least one hydraulic component in a vehicle may be carried out, is described below in light of the drawings.

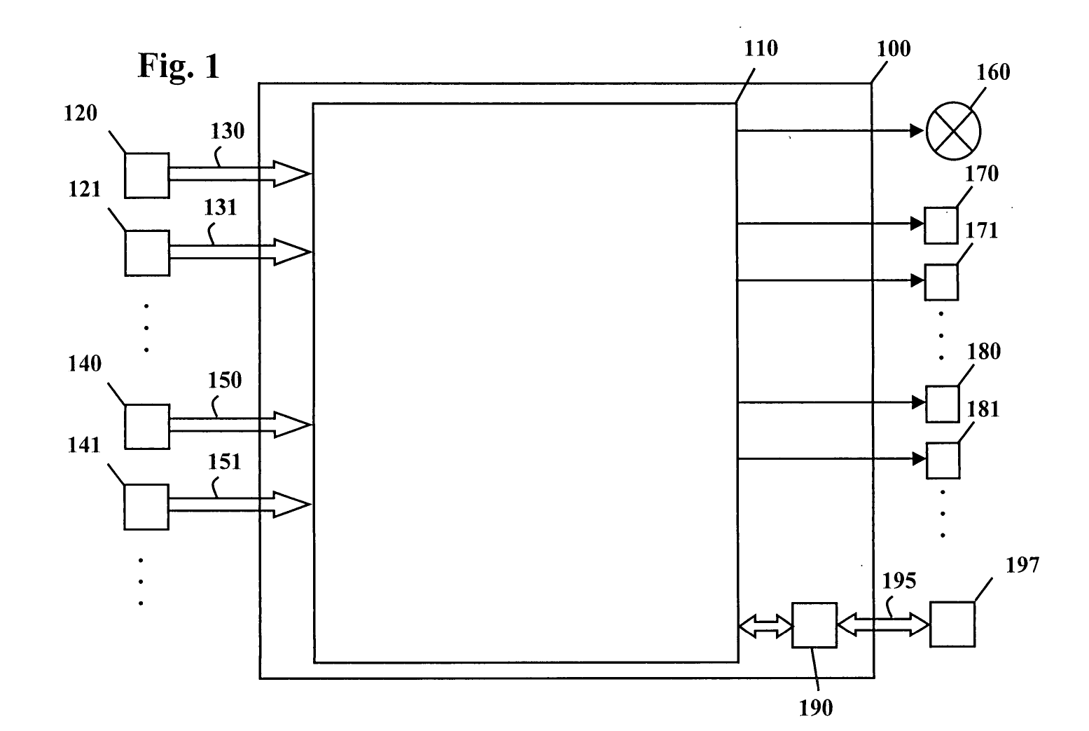

The acquisition of the operating data from the open-loop and closed-loop control systems of the monitored components of a vehicle is represented in FIG. 1. In this context, it is possible for an open-loop and/or closed-loop control system to contain functions relative to both driving safety and travel comfort. Thus, functions, which are relevant to driving safety and are implemented by systems such as ABS, TCS, VCS, EPB, and ACC, may be checked for their functionality.

In the present exemplary embodiment, e.g. two systems 120 and 121 relevant to driving safety are shown in FIG. 1. The representation is only limited to two systems for the sake of clarity and may easily be expanded. By querying systems 120 and 121, operating data (130, 131) of the system functions relevant to driving safety may be fetched out. In addition, the vehicle has functions, which are relevant to travel comfort and implemented by systems such as ALSD, EPB, and ACC. For purely technical display reasons, only two systems 140 and 141 relevant to travel comfort are represented in the present exemplary embodiment, as in the case of systems (120, 121) relevant to driving safety. In this case, it is also possible to expand to further systems without any problem. Operating data (150, 151) of functions relevant to driving safety may also be read out of the open-loop and closed-loop control systems in the same way as the operating data of the functions relevant to driving safety. Threshold values, which are used to compare individual components or to compare the overall loading of several components, may be read in from a memory 190. In addition, the measuring loadings of the monitored components, as well as the result of comparing the recorded, instantaneous loading to the threshold values, may also be stored in memory 190. Using a query 195, e.g. by a service technician during a routine garage visit 197, the result of the comparison, i.e. the accumulated loading of the components may be read out. New threshold values representing the maximum loading of the components may be written into the memory via memory access 195. Thus, the threshold value and, therefore, the ultimate loading may be updated when a hydraulic component is exchanged. After current operating data (130, 131 and 150, 151) are compared to the threshold values read in, a decision based on the comparison may be made as to which functions relevant to travel comfort and/or safety are to be modified, in order to ensure safe operation of the vehicle. This may be accomplished by prioritizing the modification of the functions included in the systems, as is implemented in block 110. By extracting the modifications from preceding cycles, which are stored in memory 190, the prioritization may be accomplished by selecting the functions still available. In addition to modifying or shutting down functions (170, 171 ff.) relevant to travel comfort or modifying functions (180, 181 ff.) relevant to driving safety, the driver may be informed about the result of the monitoring (160). In this context, the driver may be informed by an acoustic and/or optical warning, that certain functions are no longer available or only work in a limited manner. Equally conceivable is driver information, which gives detailed information about the monitoring and the modification or partial shut-down of individual functions.

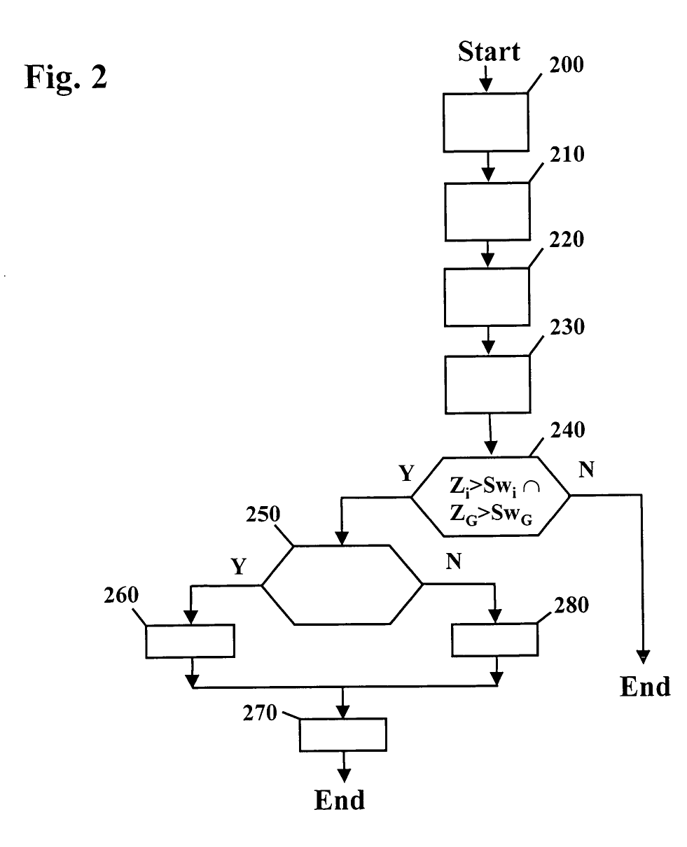

The functioning method of the monitoring of at least one hydraulic component is shown in the flow chart of FIG. 2. In step 200, after the start of the program, the memory is read out, and it is determined, which components are present in the vehicle and may be controlled. Counters Zᵢ and Z_{G} represent the loading of the i^{th} components and the overall loading from previous monitoring cycles, respectively. Threshold values, which represent the possible, maximum loading of the i^{th} component and the maximum overall loading of the components, are read in, using SWᵢ and SW_{G}, respectively. In subsequent step 210, the operating data of the monitored and controlled components are acquired for ascertaining the component loading. The operating data may include the switching-on frequency and the on-period of the pump or pump motor in various pressure classes, or of the solenoid valves in various voltage classes. In addition, it is possible to detect the temperature of the hydraulic components and their control units as further parameters. After the operating data are received, a normalized loading Bᵢ is obtained for each component with the aid of a stress model. In step 220, the loading Bᵢ of the i^{th} component obtained in this manner is used to modify counters Zᵢ, i.e. counters Zᵢ are advanced as a function of normalized values Bi. Variable Z_{G} is calculated as the overall loading, from the sum of the counters of the i-components, i.e.:

$${Z}_{G} = {\sum }_{i} {Z}_{i}$$

In step 230, the values of Zᵢ and Z_{G} obtained in this manner are stored in memory 190, so that they are available for the next monitoring cycle and/or for service work.

In step 240, the loading of the monitored hydraulic components from previous monitoring cycles, which is represented by counters Zᵢ and Z_{G}, is compared to predefined threshold values SWᵢ and SW_{G}, respectively, according to:

Zᵢ>SWᵢ

or

Z_{G}>SW_{G}

If the threshold value and, therefore, the possible, maximum loading (critical loading) is exceeded in one of the comparisons in step 240, then suitable measures may be taken. But, if it is determined that none of the loadings exceed the predefined threshold value (limiting value), then the program is ended. If it is determined that, in step 240, the loading is exceeded in at least one of the system components, then, in step 250, it is checked if comfort-relevant systems or functions are being controlled in the current operation. If comfort functions were controlled during the monitoring cycle, then the control of the comfort-relevant functions is prioritized in step 270. Consequently, modifications to the control are carried out on the selected comfort functions. This may range from limiting the mode of operation to the extreme case of shutting down individual functions or entire systems. Thus, it is possible, for example, to reduce the closed-loop control dynamics by reducing the switching-on frequency and the on-period of the solenoid valves. The information regarding the undertaken modification of the control is stored in memory 190 for subsequent monitoring cycles and service purposes. In step 270, the driver of the vehicle is finally informed about the modification or partial shut-down of the relevant functions or systems, before the program is ended and/or restarted. If it is determined, in step 250, that no systems or functions relevant to comfort are being controlled, then the option of modifying the control of the systems or functions, which are relevant to safety and are in operation in the vehicle, is implemented in step 280. An optimum utilization of the components may be achieved by selecting the functions or systems relevant to driving safety. Thus, a reduction in the response sensitivity of suitable systems may result in small requests not being implemented or only being implemented after a delay. This measure allows the switching-on frequency of the systems and, thus, the loading, which, e.g. acts on the components in the form of wear, to be reduced during the operation of the vehicle, without bringing the vehicle performance into critical driving situations. For subsequent open-loop and/or closed-loop control processes, the control modifications undertaken may be stored in memory 190. In step 290, the driver receives information in the same way as in the case of the modification of comfort-relevant functions or systems.

In addition to the comparison of the summed-up loading of the monitored hydraulic components, as occurs in the first exemplary embodiment with counter Zᵢ for every i^{th} component and Z_{G} for the overall loading of all monitored components, a further exemplary embodiment also allows a comparison of instantaneous loading Bᵢ to corresponding threshold values SW_{Bi}. To this end, it is necessary to store a threshold value of current loading SW_{Bi} in memory 190 for every i^{th} component. In this context, this threshold value may be read in in step 200 in a manner analogous to the sequence described at the outset. In step 250, it can be decided if, and which, function or system is overloaded by comparing instantaneous loading Bᵢ to threshold values SW_{Bi} read in. In this context, the control or modification of the control is accomplished according to the above-described exemplary embodiment.

### LIST OF REFERENCE CHARACTERS

∩ logical OR

Bᵢ loading of the i^{th} components

Z_{G} counter that measures the loading of the entire system

Zᵢ counter that measures the loading of the i^{th} components

SW_{G} threshold value representing a warning threshold with respect to the maximum loading of the entire system

SWᵢ threshold value representing a warning threshold with respect to the maximum loading of the i^{th} components

120, 121 vehicle function relevant to driving safety

130, 131 operating data of the functions relevant to driving safety

140, 141 vehicle functions relevant to travel comfort

150, 151 operating data of the functions relevant to travel comfort

160 indicator

170, 171 systems relevant to driving comfort

180, 181 systems relevant to driving safety

180 memory

190 service/garage

195 data query or initialization

What is claimed is:

1. A method for monitoring at least one hydraulic component in a vehicle, comprising:
measuring a wear-causing loading of the at least one hydraulic component to produce a measured loading;
providing the wear-causing loading on the basis of a braking request; and
performing a comparison of the measured loading to at least one specifiable threshold value.

2. The method as recited in claim 1, further comprising:
initiating a specifiable measure for reducing the wear-causing loading as a function of the comparison.

3. The method as recited in claim 1, further comprising at least one of:
measuring an instantaneous loading of the at least one hydraulic component during an operation of the vehicle; and
determining an overall loading of the at least one hydraulic component from at least one previous loading.

4. The method as recited in claim 1, further comprising:
detecting when the wear-causing loading exceeds the at least one specifiable threshold value; and
calculating at least one threshold value for at least one of:
each one of the at least one hydraulic component, and
at least two of the at least one hydraulic component.

5. The method as recited in claim 1, further comprising:
performing at least one modification of an operation of at least one of an open-loop control system and a closed-loop control system that are situated in the vehicle in order to control the at least one hydraulic component; and
implementing the at least one modification of an individual system function in at least two modes as a function of the wear-causing loading.

6. The method as recited in claim 5, wherein:
the at least one modification includes a partial shut-down.

7. The method as recited in claim 5, further comprising:
in a first mode of the at least two modes, modifying at least one of the open-loop control system and the closed-loop control system relating to a control of at least one function in the vehicle relevant to travel comfort along the lines of minimizing the wear-causing loading; and
in a second mode of the at least two modes, modifying at least one of the open-loop control system and the closed-loop control system relating to a control of at least one function relevant to driving safety as a function of the first mode along the lines of minimizing the wear-causing loading.

8. The method as recited in claim 7, wherein:
the modifying of the at least one of the open-loop control system and the closed-loop control system involves performing a partial shut-down of the at least one function relevant to driving comfort.

9. The method as recited in claim 7, further comprising:
prioritizing the modification of the first mode and the modification of the second mode.

10. The method as recited in claim 1, wherein:
the at least one specifiable threshold value represents a maximum loading of a system during operation.

11. The method as recited in claim 10, further comprising:
storing the maximum loading of the system in a non-volatile memory.

12. The method as recited in claim 1, wherein the at least one hydraulic component includes at least one of:
a valve,
a hydraulic fluid, and
a pump.

13. The method as recited in claim 5, wherein at least one of the open-loop control system and the closed-loop control system controls at least one of:
a brake,
a differential,
a valve,
a pump, and
an engine of the vehicle.

14. The method as recited in claim 1, wherein the wear-causing loading includes at least one of:
a pressure,
a temperature, and
an operating voltage.

15. A device for monitoring at least one hydraulic component in a vehicle, comprising:
an arrangement for measuring a wear-causing loading of the at least one hydraulic component to produce a measured loading;
an arrangement for providing the wear-causing loading on the basis of a braking request; and
an arrangement for performing a comparison of the measured loading to at least one specifiable threshold value.

16. The device as recited in claim 15, further comprising:
an arrangement for initiating a specifiable measure as a function of the comparison.

17. The device as recited in claim 16, wherein:
the specifiable measure is for reducing the wear-causing loading.

18. The device as recited in claim 15, further comprising:
an arrangement for detecting when the wear-causing loading exceeds the at least one specifiable threshold value; and
an arrangement for calculating a different one of the at least one specifiable threshold value for at least one of:
each one of the at least one hydraulic component, and
at least two of the at least one hydraulic component.

19. The method as recited in claim 15, further comprising:
an arrangement for performing at least one modification of an operation of at least one of an open-loop control system and a closed-loop control system that are situated in the vehicle in order to control the at least one hydraulic component; and
an arrangement for implementing the at least one modification of an individual system function in at least two modes as a function of the wear-causing loading.

20. A computer program including program code that when executed on a processing device causes a performance of the following:
measuring a wear-causing loading of at least one hydraulic component to produce a measured loading;
providing the wear-causing loading on the basis of a braking request; and
performing a comparison of the measured loading to at least one specifiable threshold value.

21. A computer program product including program code stored on one of a computer-readable storage medium and a corresponding processing unit, the program code when executed results in a performance of the following:
measuring a wear-causing loading of at least one hydraulic component to produce a measured loading;
providing the wear-causing loading on the basis of a braking request; and
performing a comparison of the measured loading to at least one specifiable threshold value.
